(19) United States
(12) Patent Application Publication
(10) Pub. No.: US 2008/0297742 A1
(43) Pub. Date: Dec. 4, 2008

(54) Projector apparatus

(75) Inventors: Keiichi Muneishi, Tokyo (JP); Hideaki Kosaka, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 12/153,861

(22) Filed: May 27, 2008

(30) Foreign Application Priority Data
May 31, 2007 (JP) JP2007-144442

(51) Int. Cl. G03B 21/53

(52) U.S. Cl. 353/101

(57) ABSTRACT

A projector apparatus capable of adjusting a projecting image without the user manually adjusting the image or selecting the past setting information for every usage opportunity. A projector apparatus according to the present invention is a projector apparatus capable of performing automatic adjustment based on past setting information related to before-use adjustment; the projector apparatus including an identification information receiving device for receiving, at an arbitrary installation location, information specific to the installation location; and a CPU for executing the automatic adjustment based on the specific information received by the identification information receiving device.

### BACKGROUND OF THE INVENTION

1. Field of the Invention

The present invention relates to a projector apparatus used by changing installing locations.

2. Description of the Background Art

In the conventional projector apparatus, the installation location is changed for every usage opportunity excluding a ceiling suspension type projector or a so-called ceiling projector. Thus, the setting related to the adjustment of a projecting image needs to be changed for every usage opportunity. This setting includes focus setting, resolution, input setting, and the like, and is basically carried out by the user manually. Thus, to those who are not familiar with the adjustment operation of the projector apparatus, the device may be hard to use, and considerable time is required.

In order to resolve this problem, Japanese Patent Application Laid-Open No. 2003-295321 (P. 1) discloses a projector apparatus in which a plurality of past setting information related to the before-use adjustment are stored in a memory in advance, and automatic adjustment is made based on the past setting information selected by a condition selecting key of a remote controller. According to such projector apparatus, the projecting image can be automatically adjusted after turning ON the power based on the past setting information stored in the memory.

However, in the conventional projector apparatus, the user needs to select the past setting information for every usage opportunity, and the past setting information may not always be appropriately selected. Thus, when the user selects erroneous past setting information, a task of adjusting the projecting image arises, and to those who are not familiar with the operation of the projector apparatus, considerable time is still required.

### SUMMARY OF THE INVENTION

The present invention aims to provide a projector apparatus capable of adjusting a projecting image without the user manually adjusting the image or selecting the past setting information for every usage opportunity.

A projector apparatus according to the present invention is a projector apparatus capable of performing automatic adjustment based on the past setting information related to before-use adjustment; the projector apparatus including a receiving part for receiving, at an arbitrary installation location, information specific to the installation location; and a controlling part for executing the automatic adjustment based on the specific information received by the receiving part.

The projecting image can be automatically adjusted without the user manually adjusting the image or selecting the past setting information for every usage opportunity.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a projector apparatus according to a first embodiment;

FIG. 2 is a block diagram showing a configuration of a projector apparatus according to second and third embodiments;

FIG. 3 is a block diagram showing a configuration of a projector apparatus according to fourth and fifth embodiments;

FIG. 4 is a block diagram showing a configuration of a projector apparatus according to sixth and eighth embodiments; and

FIG. 5 is a block diagram showing a configuration of a projector apparatus according to seventh and ninth embodiments.

### DESCRIPTION OF THE PREFERRED EMBODIMENTS

### First Embodiment

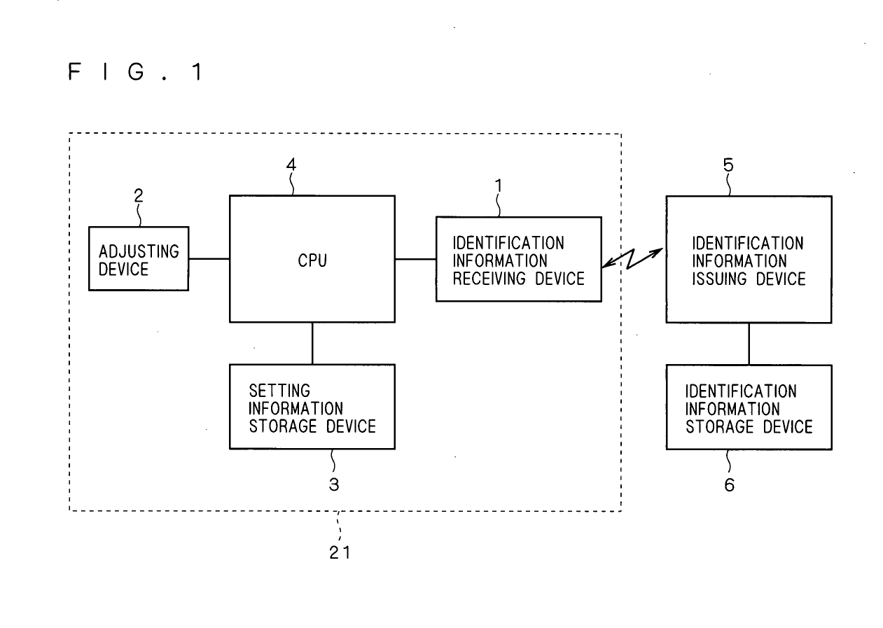

FIG. 1 is a block diagram showing a configuration of a projector apparatus according to the present embodiment. A projector apparatus 21 according to the present embodiment is a projector apparatus capable of performing automatic adjustment based on past setting information related to before-use adjustment, and includes an identification information receiving device 1, an adjusting device 2, a setting information storage device 3, and a CPU (Central Processing Unit) 4.

The identification information receiving device 1 serving as a receiving part in the present embodiment receives, at an arbitrary installation location, information specific to the relevant installation location. In the present embodiment, the specific information is stored in advance in an identification information storage device 6 arranged at the arbitrary installation location of the projector apparatus 21. In the present embodiment, the specific information is location associated identification information associated with the installation information, and corresponds to location information assigned for every installation location or identification information assigned for every identification information storage device 6.

The location associated identification information stored in advance in the identification information storage device 6 is read by an identification information issuing device 5 arranged at the arbitrary installation location of the projector apparatus 21, and transmitted to the projector apparatus 21. The identification information receiving device 1 of the projector apparatus 21 receives the location associated identification information transmitted from the identification information issuing device 5, and transmits the same to the CPU 4. The identification information receiving device 1 serving as the receiving part thus receives, at an arbitrary installation location, the location associated identification information associated with the installation location.

The setting information storage device 3 serving as the storage part stores in advance the past setting information in association with the location associated identification information by the control of the CPU 4. The setting information includes set values related to the adjustment of focus, size, or field angle. The setting information differs according to the position relationship of the projector apparatus 21 and the screen. The adjusting device 2 is arranged in singular or in plurals, and automatically adjusts the focus, size, or the field angle of the projecting image by the control of the CPU 4.

The CPU 4 reads out the corresponding past setting information from the setting information storage device 3 based on the location associated identification information transmitted from the identification information receiving device 1. If the past setting information is stored in advance in the setting information storage device 3, the CPU 4 controls the adjusting device 2 based on the past setting information, and executes automatic adjustment. Thus, the CPU 4 serving as a controlling part executes automatic adjustment based on the location associated identification information received by the identification information receiving device 1.

According to the projector apparatus 21 of the present embodiment configured as above, the past setting information is read out based on the information specific to the arbitrary installation location. Automatic adjustment is then executed based on the read past setting information. The projecting image thus can be automatically adjusted without the user manually adjusting the image or selecting the past setting information for every usage opportunity.

### Second Embodiment

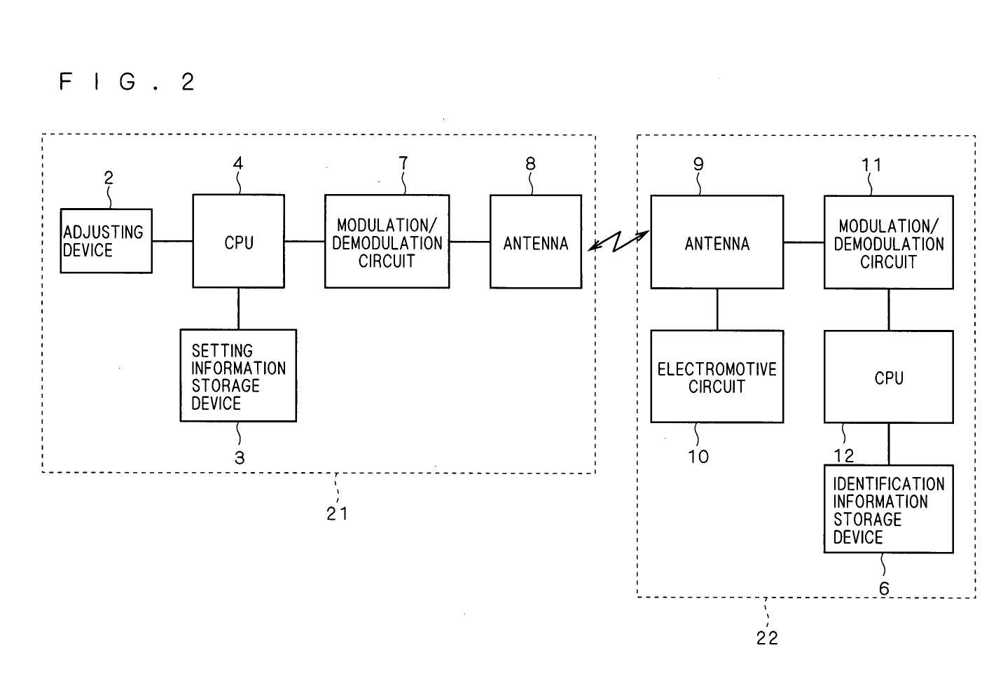

FIG. 2 is a block diagram showing a configuration of a projector apparatus according to the present embodiment. In the first embodiment, the identification information issuing device 5 and the identification information storage device 6 are arranged at an arbitrary installation location separate from the projector apparatus 21. The identification information issuing device 5 and the identification information storage device 6 preferably have a small size, do not have a power supply, and are capable of wirelessly communicating with the projector apparatus 21. A passive tag 22 is thus used in the present embodiment.

The projector apparatus 21 according to the present embodiment can perform automatic adjustment based on the past setting information related to the before-use adjustment, and includes the adjusting device 2, the setting information storage device 3, the CPU 4, a modulation/demodulation circuit 7, and an antenna 8, as shown in FIG. 2. The adjusting device 2 is the same device as in the first embodiment.

The passive tag 22 according to the present embodiment includes the identification information storage device 6, an antenna 9, an electromotive circuit 10, a modulation/demodulation circuit 11, and a CPU 12.

The antenna 8 serving as a receiving part in the present embodiment receives, at an arbitrary installation location, information specific to the relevant installation location. In the present embodiment, the specific information is location associated identification information associated with the installation location, and corresponds to the location information assigned for every installation location, or authentication tag information assigned for every passive tag 22. In the present embodiment, the location associated identification information is provided in the form of reflected wave etc. from the passive tag 22 arranged at the arbitrary installation location of the projector apparatus 21.

The setting information storage device 3 serving as the storage part stores in advance the past setting information in association with the location associated identification information. This operation is performed by the control of the CPU 4. The CPU 4 serving as the controlling part executes automatic adjustment based on the location associated identification information received by the antenna 8.

The operation of the projector apparatus 21 according to the present embodiment configured as above will now be described. First, the CPU 4 issues a read command. The modulation/demodulation circuit 7 modulates the read command. The antenna 8 of the projector apparatus 21 transmits the modulated read command to the passive tag 22. The antenna 8 transmits a predetermined electric wave to the passive tag 22 from before transmitting the modulated read command until receiving the modulated location associated identification information to be hereinafter described.

The antenna 9 of the passive tag 22 receives the predetermined electric wave transmitted from the antenna 8 of the projector apparatus 21. The electromotive circuit 10 generates power to be used in the operation of the circuits in the passive tag 22 from the predetermined electric wave received by the antenna 9.

After receiving the predetermined electric wave, the antenna 9 of the passive tag 22 receives the modulated read command transmitted from the antenna 8 of the projector apparatus 21. The modulation/demodulation circuit 11 demodulates the modulated read command, and transmits the read command to the CPU 12.

After receiving the read command, the CPU 12 reads out the location associated identification information from the identification information storage device 6, and transmits the same to the modulation/demodulation circuit 11. The modulation/demodulation circuit 11 modulates the location associated identification information transmitted from the CPU 12. The antenna 9 of the passive tag 22 transmits the modulated location associated identification information to the projector apparatus 21 with the reflected wave of the electric wave from the projector apparatus 21. In the present embodiment, the location associated identification information is provided from the passive tag 22 arranged at the arbitrary installation location.

The antenna 8 of the projector apparatus 21 receives the modulated location associated identification information transmitted from the passive tag 22. Thus, the antenna 8 receives the location associated identification information related to the relevant installation location at the arbitrary installation location. The modulation/demodulation circuit 7 demodulates the modulated location associated identification information, and transmits the location associated identification information to the CPU 4.

The CPU 4 reads out the corresponding past setting information from the setting information storage device 3 based on the location associated identification information transmitted from the modulation/demodulation circuit 7. If the past setting information is stored in advance in the setting information storage device 3, the CPU 4 controls the adjusting device 2 based on the past setting information, and executes automatic adjustment. Thus, the CPU 4 executes automatic adjustment based on the location associated identification information received by the antenna 8.

According to the projector apparatus 21 of the present embodiment performing the above operation, the past setting information is read out according to the location associated identification information provided from the passive tag 22 installed at the arbitrary installation location. The automatic adjustment is executed based on the read past setting information. Thus, similar to the first embodiment, the projecting image can be automatically adjusted without the user manually adjusting the image or selecting the past setting information for every usage opportunity.

### Third Embodiment

The configuration of the projector apparatus according to the present embodiment is the same as the block diagram shown in FIG. 2. In the present embodiment, if a new before-use adjustment is made in the projector apparatus 21, the setting information storage device 3 stores the location associated identification information provided from the passive tag 22 and the current setting information in association with each other. In the configuration of the projector apparatus according to the present embodiment, same reference numerals are denoted for the same configurations as in the second embodiment, and the configuration that will not be newly described is assumed to be the same as the second embodiment.

The operation of the projector apparatus 21 according to the present embodiment configured as above will now be described. First, the CPU 4 issues a read command. The modulation/demodulation circuit 7 modulates the read command. The antenna 8 of the projector apparatus 21 transmits the modulated read command to the passive tag 22. The antenna 8 transmits a predetermined electric wave to the passive tag 22 from before transmitting the modulated read command until receiving the modulated location associated identification information to be hereinafter described.

The antenna 9 of the passive tag 22 receives the predetermined electric wave transmitted from the antenna 8 of the projector apparatus 21. The electromotive circuit 10 generates power to be used in the operation of the circuits in the passive tag 22 from the predetermined electric wave received by the antenna 9.

After receiving the predetermined electric wave, the antenna 9 of the passive tag 22 receives the modulated read command transmitted from the antenna 8 of the projector apparatus 21. The modulation/demodulation circuit 11 demodulates the modulated read command, and transmits the read command to the CPU 12.

After receiving the read command, the CPU 12 reads out the location associated identification information from the identification information storage device 6, and transmits the same to the modulation/demodulation circuit 11. The modulation/demodulation circuit 11 modulates the location associated identification information transmitted from the CPU 12. The antenna 9 of the passive tag 22 transmits the modulated location associated identification information to the projector apparatus 21 with the reflected wave of the electric wave from the projector apparatus 21.

The antenna 8 of the projector apparatus 21 receives the modulated location associated identification information transmitted from the passive tag 22. The modulation/demodulation circuit 7 demodulates the modulated location associated identification information, and transmits the location associated identification information to the CPU 4.

The description up to here is the same as the second embodiment. In the present embodiment, if a new before-use adjustment is made in the projector apparatus 21, the setting information storage device 3 stores the location associated identification information provided from the passive tag 22 and the current setting information in association with each other. This operation is performed by the control of the CPU 4, and the like.

According to the projector apparatus 21 of the present embodiment performing the above operation, similar to the second embodiment, the projecting image can be automatically adjusted without the user manually adjusting the image or selecting the past setting information for every usage opportunity with respect to the next and subsequent use.

Furthermore, the current setting information can be stored in the setting information storage device 3 as past information without the user performing a predetermined task. Thus, when arranging and using the projector apparatus 21 at the relevant installation location the next time, the past setting information can be read based on the stored location associated identification information.

### Fourth Embodiment

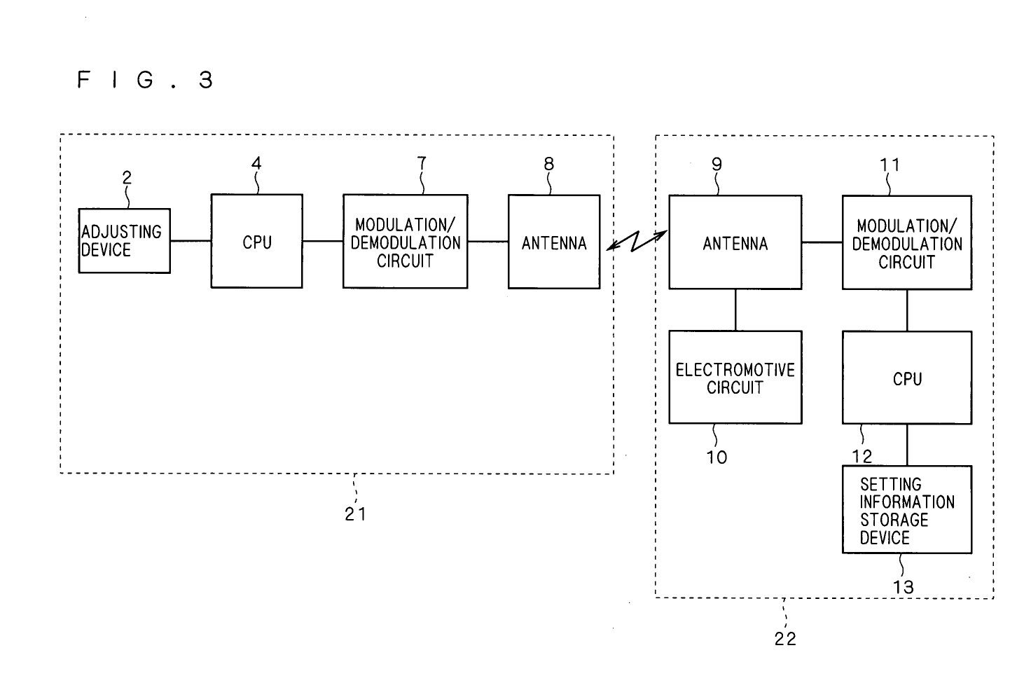

FIG. 3 is a block diagram showing a configuration of a projector apparatus according to the present embodiment. The projector apparatus 21 according to the present embodiment can perform automatic adjustment based on the past setting information related to the before-use adjustment, and includes the adjusting device 2, the CPU 4, the modulation/demodulation circuit 7, and the antenna 8, as shown in FIG. 3. The adjusting device 2 is the same device as in the first embodiment.

The passive tag 22 according to the present embodiment includes the antenna 9, the electromotive circuit 10, the modulation/demodulation circuit 11, the CPU 12, and a setting information storage device 13. The difference with the above described embodiments is that the setting information storage device 3 is not arranged in the projector apparatus 21, and a setting information storage device 13 is arranged in the passive tag 22 in place of the identification information storage device 6.

The antenna 8 serving as the receiving part in the present embodiment receives, at an arbitrary installation location, information specific to the relevant installation location. The specific information is past setting information in the present embodiment. In the present embodiment, the past setting information is provided in the form of reflected wave etc. from the passive tag 22 arranged at the arbitrary installation location of the projector apparatus 21. The CPU 4 serving as the controlling part executes automatic adjustment based on the past setting information received by the antenna 8.

The operation of the projector apparatus 21 according to the present embodiment configured as above will now be described. First, the CPU 4 issues the read command and projector identification information. The projector identification information is identification information assigned for every projector apparatus 21. The modulation/demodulation circuit 7 modulates the read command and the projector identification information. The antenna 8 of the projector apparatus 21 transmits the modulated read command and the modulated projector identification information to the passive tag 22. The antenna 8 transmits a predetermined electric wave to the passive tag 22 from before transmitting the information until receiving the modulated past setting information to be hereinafter described.

The antenna 9 of the passive tag 22 receives the predetermined electric wave transmitted from the antenna 8 of the projector apparatus 21. The electromotive circuit 10 generates power to be used in the operation of the circuits in the passive tag 22 from the predetermined electric wave received by the antenna 9.

After receiving the predetermined electric wave, the antenna 9 of the passive tag 22 receives the modulated read command and the modulated projector identification information transmitted from the antenna 8 of the projector apparatus 21. The modulation/demodulation circuit 11 demodulates the modulated read command and the modulated projector identification information, and transmits the read command and the projector identification information to the CPU 12.

The past setting information is stored in advance in the setting information storage device 13 in association with the projector identification information. After receiving the read command and the projector identification information, the CPU 12 reads out the corresponding past setting information from the setting information storage device 13 based on the received projector identification information, and transmits the same to the modulation/demodulation circuit 11. The modulation/demodulation circuit 11 modulates the past setting information transmitted from the CPU 12. The antenna 9 of the passive tag 22 transmits the modulated past setting information to the projector apparatus 21 with the reflected wave of the electric wave from the projector apparatus 21. Thus, in the present embodiment, the past setting information is provided from the passive tag 22 arranged at the arbitrary installation location.

The antenna 8 of the projector apparatus 21 receives the modulated past setting information transmitted from the passive tag 22. Thus, the antenna 8 receives the past setting information or the information specific to the relevant installation location at the arbitrary installation location. The modulation/demodulation circuit 7 demodulates the modulated past setting information, and transmits the past setting information to the CPU 4.

The CPU 4 controls the adjusting device 2 and executes automatic adjustment based on the past setting information transmitted from the modulation/demodulation circuit 7. Thus, the CPU 4 executes automatic adjustment based on the past setting information received by the antenna 8.

According to the projector apparatus 21 of the present embodiment performing the above operation, automatic adjustment is executed based on the past setting information provided from the passive tag 22 installed at the arbitrary installation location. Thus, the projecting image can be automatically adjusted without the user manually adjusting the image or selecting the past setting information for every usage opportunity. Moreover, the setting information storage device 3 can be omitted from the projector apparatus 21 as opposed to the above described embodiments.

### Fifth Embodiment

The configuration of the projector apparatus according to the present embodiment is the same as the block diagram shown in FIG. 3. In the present embodiment, the projector apparatus 21 writes current setting information to the passive tag 22 when a new before-use adjustment is made in the projector apparatus 21. In the configuration of the projector apparatus according to the present embodiment, same reference numerals are denoted for the same configurations as in the fourth embodiment, and the configuration that will not be newly described is assumed to be the same as the fourth embodiment.

The operation of the projector apparatus 21 according to the present embodiment configured as above will now be described. First, the CPU 4 issues a write command and transmits the write command and the current setting information to the modulation/demodulation circuit 7. The modulation/demodulation circuit 7 modulates the write command and the current setting information. The antenna 8 of the projector apparatus 21 transmits the modulated write command and the modulated current setting information to the passive tag 22. The antenna 8 transmits a predetermined electric wave to the passive tag 22 from before transmitting the information until receiving the modulated past setting information.

The antenna 9 of the passive tag 22 receives the predetermined electric wave transmitted from the antenna 8 of the projector apparatus 21. The electromotive circuit 10 generates power to be used in the operation of the circuits in the passive tag 22 from the predetermined electric wave received by the antenna 9.

After receiving the predetermined electric wave, the antenna 9 of the passive tag 22 receives the modulated write command and the modulated current setting information transmitted from the antenna 8 of the projector apparatus 21. The modulation/demodulation circuit 11 demodulates the modulated write command and the modulated current setting information, and transmits the write command and the current setting information to the CPU 12. After receiving the write command and the current setting information, the CPU 12 stores the current setting information in the setting information storage device 13. Thus, in the present embodiment, when new before-use adjustment is made in the projector apparatus 21, the projector apparatus 21 writes the current setting information to the passive tag 22.

According to the projector apparatus 21 of the present embodiment performing the above operation, similar to the fourth embodiment, the projecting image can be automatically adjusted without the user manually adjusting the image or selecting the past setting information for every usage opportunity with respect to the next and subsequent use.

Furthermore, the current setting information can be written in the passive tag 22 as past setting information without the user performing a predetermined task. Thus, when arranging and using the projector apparatus 21 at the relevant installation location the next time, the past setting information can be read based on the stored location associated identification information.

### Sixth Embodiment

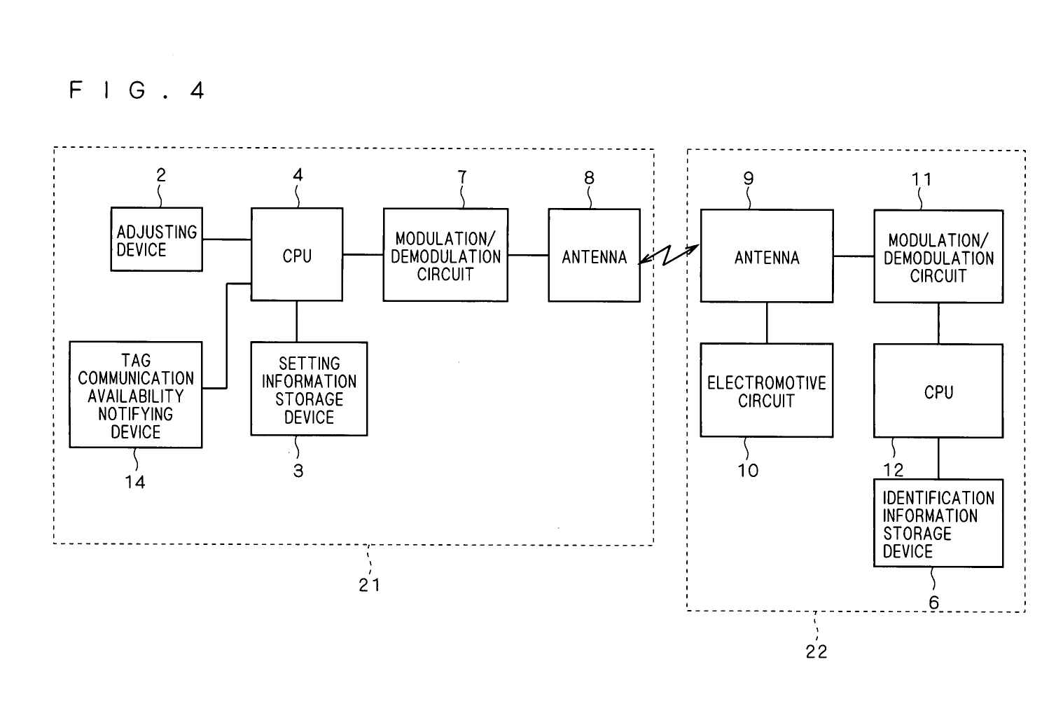

FIG. 4 is a block diagram showing a configuration of a projector apparatus according to the present embodiment. As shown in the figure, the projector apparatus 21 further includes a tag communication availability notifying device 14 in the configuration shown in the block diagram of FIG. 2. In the configuration of the projector apparatus of the present embodiment, same reference numerals are denoted for the same configurations as in the second embodiment, and the configuration that will not be newly described is assumed to be the same as the second embodiment.

The operation of the projector apparatus 21 according to the present embodiment configured as above will now be described. First, the CPU 4 issues a read command. The modulation/demodulation circuit 7 modulates the read command. The antenna 8 of the projector apparatus 21 transmits the modulated read command to the passive tag 22. The antenna 8 transmits a predetermined electric wave to the passive tag 22 from before transmitting the modulated read command until receiving the modulated location associated identification information.

The antenna 9 of the passive tag 22 receives the predetermined electric wave transmitted from the antenna 8 of the projector apparatus 21. The electromotive circuit 10 generates power to be used in the operation of the circuits in the passive tag 22 from the predetermined electric wave received by the antenna 9.

After receiving the predetermined electric wave, the antenna 9 of the passive tag 22 receives the modulated read command transmitted from the antenna 8 of the projector apparatus 21. The modulation/demodulation circuit 11 demodulates the modulated read command, and transmits the read command to the CPU 12.

After receiving the read command, the CPU 12 reads out the location associated identification information from the identification information storage device 6, and transmits the same to the modulation/demodulation circuit 11. The modulation/demodulation circuit 11 modulates the location associated identification information transmitted from the CPU 12. The antenna 9 of the passive tag 22 transmits the modulated location associated identification information to the projector apparatus 21 with the reflected wave of the electric wave from the projector apparatus 21.

The antenna 8 of the projector apparatus 21 receives the modulated location associated identification information transmitted from the passive tag 22. The modulation/demodulation circuit 7 demodulates the modulated location associated identification information, and transmits the location associated identification information to the CPU 4.

The description up to here is the same as the second embodiment. In the present embodiment, the CPU 4 repeatedly transmits the read command for every specific time period T set in advance by the designer to detect whether or not the location associated identification information returned from the passive tag 22 is received. The CPU 4 controls an internal counter having N as the count value according to whether or not the location associated identification information is received.

The tag communication availability notifying device 14 serving as the notifying part notifies to the outside that wireless communication with the passive tag 22 is valid/not valid according to whether or not the predetermined information returned from the passive tag 22 is received. In the present embodiment, the predetermined information is location associated identification information, and the tag communication availability notifying device 14 notifies to the outside that the wireless communication with the passive tag 22 is valid/not valid according to the detection result on the location associated identification information in the CPU 4. This operation will be described below.

When detecting that the location associated identification information is received for the first time, the CPU 4 performs the control of storing the location associated identification information in the setting information storage device 3. The CPU 4 sets the internal counter to N=1. In this case, the tag communication availability notifying device 14 notifies to the outside that the wireless communication with the passive tag 22 is valid by lighting the LED of a predetermined color or with a specific sound.

When detecting that the location associated identification information same as the previous time is received after a specific time period T has elapsed, the CPU 4 adds one to the internal counter. When the internal counter becomes N=M thereafter, the CPU 4 reads out the corresponding past setting information from the setting information storage device 3 based on the location associated identification information stored in the setting information storage device 3. Similar to the operation described in the second embodiment, the CPU 4 controls the adjusting device 2 based on the corresponding past setting information and executes automatic adjustment. M is a parameter set in advance by the designer, and is set in advance so that a time calculated by T×M becomes a time enough for the user to specify the installation location of the projector apparatus 21 based on the notification from the tag communication availability notifying device 14.

When detecting that the location associated identification information different from the previous time is received before the internal counter becomes N=M, the CPU 4 performs a control to erase the previously stored location associated identification information from the setting information storage device 3, and store the new location associated identification information in the setting information storage device 3. The CPU 4 resets the internal counter to N=1, and repeats the above operation. In this case as well, the tag communication availability notifying device 14 notifies to the outside that the wireless communication with the passive tag 22 is valid by lighting the LED of a predetermined color or with specific sound.

When detecting that the location associated identification information is not received, the CPU 4 performs a control to erase the location associated identification information stored in the setting storage device 3 when the internal counter is N=1. The CPU 4 then sets the internal counter to N=0. In this case, the tag communication availability notifying device 14 notifies to the outside that the wireless communication with the passive tag 22 is not valid by lighting the LED of a color different from the predetermined color mentioned above or with sound different from the specific sound mentioned above.

Thus, according to the projector apparatus 21 of the present embodiment performing the above operation, the projecting image can be automatically adjusted without the user manually adjusting the image or selecting the past setting information for every usage opportunity, similar to the second embodiment.

The user can specify the installation location at where communication between the projector apparatus 21 and the passive tag 22 can be established based on the notification from the tag communication availability notifying device 14.

### Seventh Embodiment

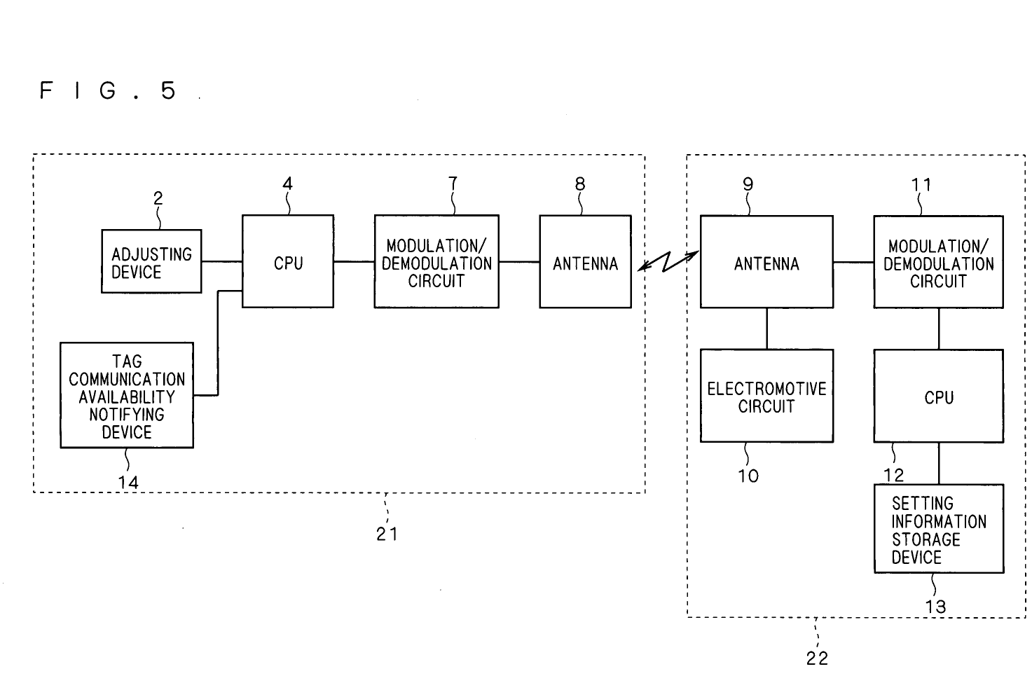

FIG. 5 is a block diagram showing a configuration of a projector apparatus according to the present embodiment. As shown in the figure, the projector apparatus 21 according to the present embodiment further includes the tag communication availability notifying device 14 in the configuration shown in the block diagram of FIG. 3. In the configuration of the projector apparatus of the present embodiment, same reference numerals are denoted for the same configurations as in the fourth embodiment, and the configuration that will not be newly described is assumed to be the same as the fourth embodiment.

The operation of the projector apparatus 21 according to the present embodiment configured as above will now be described. First, the CPU 4 issues a recognition notification command. The modulation/demodulation circuit 7 modulates the recognition notification command. The antenna 8 of the projector apparatus 21 transmits the modulated recognition notification command to the passive tag 22. The antenna 8 transmits a predetermined electric wave to the passive tag 22 from before transmitting the modulated recognition notification command until receiving the modulated past setting information.

The antenna 9 of the passive tag 22 receives the predetermined electric wave transmitted from the antenna 8 of the projector apparatus 21. The electromotive circuit 10 generates power to be used in the operation of the circuits in the passive tag 22 from the predetermined electric wave received by the antenna 9.

After receiving the predetermined electric wave, the antenna 9 of the passive tag 22 receives the modulated recognition notification command transmitted from the antenna 8 of the projector apparatus 21. The modulation/demodulation circuit 11 demodulates the modulated recognition notification command, and transmits the recognition notification command to the CPU 12.

After receiving the recognition notification command, the CPU 12 issues a recognition status, and transmits the same to the modulation/demodulation circuit 11. The modulation/demodulation circuit 11 modulates the recognition status transmitted from the CPU 12. The antenna 9 of the passive tag 22 transmits the modulated recognition status to the projector apparatus 21 with the reflected wave of the electric wave from the projector apparatus 21.

The antenna 8 of the projector apparatus 21 receives the modulated recognition status transmitted from the passive tag 22. The modulation/demodulation circuit 7 demodulates the modulated recognition status, and transmits the recognition status to the CPU 4.

In the present embodiment, the CPU 4 repeatedly transmits the recognition notification command for every predetermined time period T set in advance by the designer to detect whether or not the recognition status returned from the passive tag 22 is received. The CPU 4 controls the internal counter having N as the count value according to whether or not the recognition status is received.

The tag communication availability notifying device 14 serving as the notifying part notifies to the outside that wireless communication with the passive tag 22 is valid/not valid according to whether or not the predetermined information returned from the passive tag 22 is received. In the present embodiment, the predetermined information is the recognition status, and the tag communication availability notifying device 14 notifies to the outside that the wireless communication with the passive tag 22 is valid/not valid according to the detection result on the recognition status in the CPU 4. This operation will be described below.

When detecting that the recognition status is received for the first time, the CPU 4 sets the internal counter arranged therein to N=1. In this case, the tag communication availability notifying device 14 notifies to the outside that the wireless communication with the passive tag 22 is valid by lighting the LED of a predetermined color or with a specific sound.

When detecting that the recognition status is received even after a specific time period T has elapsed, the CPU 4 adds one to the internal counter. When the internal counter becomes N=M thereafter, the CPU 4 issues the read command and the project identification information. Subsequently, similar to the operation in the fourth embodiment, the CPU 4 controls the adjusting device 2 based on the past setting information provided from the passive tag 22 and executes automatic adjustment. M is a parameter set in advance by the designer, and is set in advance so that a time calculated by T×M becomes a time enough for the user to specify the installation location of the projector apparatus 21 based on the notification from the tag communication availability notifying device 14.

When detecting that the recognition status is not received, the CPU 4 sets the internal counter to N=0. In this case, the tag communication availability notifying device 14 notifies to the outside that the wireless communication with the passive tag 22 is not valid by lighting the LED of a color different from the predetermined color mentioned above or with sound different from the specific sound mentioned above.

Thus, according to the projector apparatus 21 of the present embodiment performing the above operation, the projecting image can be automatically adjusted without the user manually adjusting the image or selecting the past setting information for every usage opportunity, similar to the fourth embodiment.

The user can specify the installation location at where communication between the projector apparatus 21 and the passive tag 22 can be established based on the notification from the tag communication availability notifying device 14.

### Eighth Embodiment

The configuration of the projector apparatus according to the present embodiment is the same as the block diagram shown in FIG. 4. The projector apparatus 21 according to the present embodiment stops the wireless communication with the passive tag 22 when automatic adjustment is completed, or when automatic adjustment cannot be performed even after a predetermined time has elapsed. A case in which automatic adjustment cannot be performed even after a predetermined time has elapsed includes a case in which the corresponding past setting information is not stored in the setting information storage device 3 when the predetermined time has elapsed, and a case in which the location associated identification information is not provided at all from the passive tag 22 even after the predetermined time has elapsed in the present embodiment. In the configuration of the projector apparatus according to the present embodiment, same reference numerals are denoted for the same configuration as in the sixth embodiment, and the configuration that will not be newly described is assumed to be the same as the sixth embodiment.

The operation of the projector apparatus 21 according to the present embodiment configured as above will now be described. First, the CPU 4 issues a read command according to a predetermined operation from the user, or the start of automatic setting function of the projector apparatus 21. If the operation is performed normally, the modulation/demodulation circuit 7 transmits the location associated identification information to the CPU 4 as described in the sixth embodiment.

Similar to the sixth embodiment, the CPU 4 repeatedly transmits the read command for every specific time period T set in advance by the designer to detect whether or not the location associated identification information returned from the passive tag 22 is received.

When detecting that the location associated identification information is received for the first time, the CPU 4 performs a control of storing the location associated identification information in the setting information storage device 3. The CPU 4 sets the internal counter arranged therein to N=1. In this case, the tag communication availability notifying device 14 notifies to the outside that the wireless communication with the passive tag 22 is valid by lighting the LED of a predetermined color or with a specific sound.

When detecting that the location associated identification information same as the previous time is received after a specific time period T has elapsed, the CPU 4 adds one to the internal counter. When the internal counter becomes N=M thereafter, and the corresponding past setting information is stored in the setting information storage device 3, the CPU 4 controls the adjusting device 2 based on the corresponding past setting information and executes automatic adjustment. Subsequently, the projector apparatus 21 according to the present embodiment stops the wireless communication with the passive tag 22 when the automatic adjustment is completed. In the present embodiment, notification of the tag communication availability notifying device 14 is also stopped with the stopping of the wireless communication.

The projector apparatus 21 stops the wireless communication with the passive tag 22 also when the internal counter becomes N=M and the corresponding past setting information is not stored in the setting information storage device 3. Thus, the projector apparatus 21 according to the present embodiment stops the wireless communication with the passive tag 22 when the corresponding past setting information is not stored in the setting information storage device 3 at the time a predetermined time T×M has elapsed. In this case, the tag communication availability notifying device 14 notifies to the outside that the past setting information is not stored in the setting information storage device 3 by lighting the LED of a color different from the predetermined color mentioned above or with sound different from the specific sound mentioned above in the present embodiment.

When detecting that the location associated identification information different from the previous time is received before the internal counter becomes N=M, the CPU 4 resets the internal counter to N=1, similar to the sixth embodiment. When detecting that the location associated identification information is not received, the CPU 4 sets the internal counter to N=0, similar to the sixth embodiment.

In the present embodiment, the CPU 4 also controls a different internal counter having P as the count value according to the count value N of the internal counter. When the internal counter is set to N=0, the CPU 4 sets the different internal counter to P=1. One is added to the P of the different internal counter every time the internal counter is continuously set to N=0.

When the different internal counter becomes P=Q thereafter, that is, when the location associated identification information is not provided at all from the passive tag 22 even after time T×Q has elapsed, the wireless communication with the passive tag 22 is stopped. Here, Q is a parameter set in advance by the designer, and is set in advance, for example, so that a time calculated by T×Q becomes a time enough for time out.

Therefore, the projector apparatus 21 according to the present embodiment stops the wireless communication with the passive tag 22 when the location associated identification information is not provided at all from the passive tag 22 even after time T×Q or a predetermined time has elapsed. In the present embodiment, the tag communication availability notifying device 14 notifies to the outside that the communication with the passive tag 22 cannot be established by lighting the LED of a color different from the color mentioned above or with sound different from the sound mentioned above.

According to the projector apparatus 21 of the present embodiment performing the above operation, the projecting image can be automatically adjusted without the user manually adjusting the image or selecting the past setting information for every usage opportunity, similar to the sixth embodiment.

The power consumption of the projector apparatus 21 can be saved since the projector apparatus 21 according to the present embodiment stops the wireless communication with the passive tag 22 when automatic adjustment is completed or when automatic adjustment cannot be performed even after a predetermined time has elapsed.

### Ninth Embodiment

The configuration of the projector apparatus according to the present embodiment is the same as the block diagram shown in FIG. 5. The projector apparatus 21 according to the present embodiment stops the wireless communication with the passive tag 22 when automatic adjustment is completed, or when automatic adjustment cannot be performed even after a predetermined time has elapsed. A case in which automatic adjustment cannot be performed even after a predetermined time has elapsed includes a case in which the corresponding past setting information is not stored in the setting information storage device 13 of the passive tag 22 when the predetermined time has elapsed, and a case in which the recognition status is not provided at all from the passive tag 22 even after the predetermined time has elapsed in the present embodiment. In the configuration of the projector apparatus according to the present embodiment, same reference numerals are denoted for the same configuration as in the seventh embodiment and the configuration that will not be newly described is assumed to be the same as the seventh embodiment.

The operation of the projector apparatus 21 according to the present embodiment configured as above will now be described. First, the CPU 4 issues a recognition notification command according to a predetermined operation from the user, or the start of automatic setting function of the projector apparatus 21. If the operation is performed normally, the modulation/demodulation circuit 7 transmits the recognition status to the CPU 4 as described in the seventh embodiment.

Similar to the seventh embodiment, the CPU 4 repeatedly transmits the recognition notification command for every specific time period T set in advance by the designer to detect whether or not the recognition status returned from the passive tag 22 is received.

When detecting that the recognition status is received for the first time, the CPU 4 sets the internal counter arranged therein to N=1. In this case, the tag communication availability notifying device 14 notifies to the outside that the wireless communication with the passive tag 22 is valid by lighting the LED of a predetermined color or with a specific sound.

When detecting that the recognition status is received after a specific time period T has elapsed, same as the previous time, the CPU 4 adds one to the internal counter. When the internal counter becomes N=M thereafter, the CPU 4 issues the read command and the projector identification information. Such information is transmitted to the CPU 12 of the passive tag 22, similar to the seventh embodiment.

The CPU 12 of the passive tag 22 provides the corresponding past setting information to the projector apparatus 21 if the corresponding past setting information is stored in the setting information storage device 13 of the passive tag 22. When receiving the corresponding past setting information, the CPU 4 of the projector apparatus 21 controls the adjusting device 2 based on the corresponding past setting information and executes automatic adjustment. Subsequently, the projector apparatus 21 according to the present embodiment stops the wireless communication with the passive tag 22 when the automatic adjustment is completed. In the present embodiment, notification of the tag communication availability notifying device 14 is also stopped with the stopping of the wireless communication.

The CPU 12 of the passive tag 22 provides an invalid status to the projector apparatus 21 if the corresponding past setting information is not stored in the setting information storage device 13 of the passive tag 22. When the CPU 4 of the projector apparatus 21 receives the invalid status, the projector apparatus 21 stops the wireless communication with the passive tag 22.

The projector apparatus 21 according to the present embodiment stops the wireless communication with the passive tag 22 when the corresponding past setting information is not stored in the setting information storage device 13 of the passive tag 22. In this case, the tag communication availability notifying device 14 notifies to the outside that the past setting information is not stored in the setting information storage device 13 by lighting the LED of a color different from the predetermined color mentioned above or with sound different from the specific sound mentioned above in the present embodiment.

When detecting that the recognition status is not received, the CPU 4 sets the internal counter to N=0, similar to the seventh embodiment. In the present embodiment, the CPU 4 also controls a different internal counter having P as the count value according to the count value N of the internal counter. When the internal counter is set to N=0, the CPU 4 sets the different internal counter to P=1. One is added to the P of the different internal counter every time the internal counter is continuously set to N=0.

When the different internal counter becomes P=Q thereafter, that is, when the recognition status is not provided at all from the passive tag 22 even after time T×Q has elapsed, the wireless communication with the passive tag 22 is stopped. Here, Q is a parameter set in advance by the designer, and is set in advance, for example, so that a time calculated by T×Q becomes a time enough for time out.

Therefore, the projector apparatus 21 according to the present embodiment stops the wireless communication with the passive tag 22 when the recognition status is not provided at all from the passive tag 22 even after time T×Q or a predetermined time has elapsed. In the present embodiment, the tag communication availability notifying device 14 notifies to the outside that the communication with the passive tag 22 cannot be established by lighting the LED of a color different from the color mentioned above or with sound different from the sound mentioned above.

According to the projector apparatus 21 of the present embodiment performing the above operation, the projecting image can be automatically adjusted without the user manually adjusting the image or selecting the past setting information for every usage opportunity, similar to the sixth embodiment.

The power consumption of the projector apparatus 21 can be saved since the projector apparatus 21 according to the present embodiment stops the wireless communication with the passive tag 22 when automatic adjustment is completed or when automatic adjustment cannot be performed even after a predetermined time has elapsed.

While the invention has been shown and described in detail, the foregoing description is in all aspects illustrative and not restrictive. It is therefore understood that numerous modifications and variations can be devised without departing from the scope of the invention.

What is claimed is:

1. A projector apparatus capable of performing automatic adjustment based on past setting information related to before-use adjustment; the projector apparatus comprising:
a receiving part for receiving, at an arbitrary installation location, information specific to the installation location; and
a controlling part for executing said automatic adjustment based on said specific information received by said receiving part.

2. The projector apparatus according to claim 1, wherein said specific information is provided from a passive tag arranged at said arbitrary installation location.

3. The projector apparatus according to claim 1, wherein said specific information includes location associated identification information associated with said installation location; and
said projector apparatus further comprises a storage part for storing in advance said past setting information in association with said location associated identification information.

4. The projector apparatus according to claim 2, wherein
said specific information includes location associated identification information associated with said installation location; and
said projector apparatus further comprises a storage part for storing in advance said past setting information in association with said location associated identification information,
said storage part stores said location associated identification information provided from said passive tag and the current state of said setting information in association with each other.

5. The projector apparatus according to claim 1, wherein said specific information includes said past setting information.

6. The projector apparatus according to claim 2, wherein
the specific information includes the past setting information; and
the current state of said setting information is written to said passive tag.

7. The projector apparatus according to claim 2, further comprising a notifying part for notifying to the outside that wireless communication with said passive tag is valid/not valid according to whether or not predetermined information returned from said passive tag is received.

8. The projector apparatus according to claim 2, wherein wireless communication with said passive tag is stopped when said automatic adjustment is completed or when said automatic adjustment cannot be performed even after a predetermined time has elapsed.
